(19) United States
(12) Patent Application Publication
(10) Pub. No.: US 2013/0244795 A1
(43) Pub. Date: Sep. 19, 2013

(54) AIR FLOW INDICATOR FOR A GAMING MACHINE

(71) Applicants: Thomas D. Waxman, Reno, NV (US); Cynthia R. Criss, Reno, NV (US)

(72) Inventors: Thomas D. Waxman, Reno, NV (US); Cynthia R. Criss, Reno, NV (US)

(73) Assignee: IGT

(21) Appl. No.: 13/419,333

(22) Filed: Mar. 13, 2012

(51) Int. Cl. A63F 9/24; G01F 15/00

(52) U.S. Cl. 463/46; 73/861.77

(57) ABSTRACT

Components of a gaming machine are cooled by generating an air flow through the gaming machine. The air flow cools the gaming machine components and is filtered by a filter. A speed of the air flow through the gaming machine is measured using an anemometer and a signal indicative of the speed of the air flow is generated. The signal may indicate, for example, that the filter or a fan that generates the air flow are in need of maintenance, or that an obstruction exists in the air flow path through the gaming machine.

### BACKGROUND

1. Field of the Described Embodiments

The present disclosure relates generally to gaming machines, and more particularly to air filtration/cooling systems within a gaming machine.

2. Description of the Related Art

Many of today's gaming casinos and other entertainment locations feature different single and multi-player gaming systems such as slot machines and video poker machines. The gaming machines may include a number of hardware and software components to provide a wide variety of game types and game playing capabilities. Exemplary hardware components may include bill validators, coin acceptors, card readers, keypads, buttons, levers, touch screens, coin hoppers, ticket printers, player tracking units and the like. Software components may include, for example, boot and initialization routines, various game play programs and subroutines, credit and payout routines, image and audio generation programs, various component modules and a random or pseudo-random number generator, among others.

Gaming machines are highly regulated to ensure fairness. In many cases, gaming machines may be operable to dispense monetary awards of a large amount of money. Accordingly, access to gaming machines is often carefully controlled. For example, in some jurisdictions, routine maintenance requires that extra personal (e.g., gaming control personal) be notified in advance and be in attendance during such maintenance. Additionally, gaming machines may have hardware and software architectures that differ significantly from those of general-purpose computers (PCs), even though both gaming machines and PCs employ microprocessors to control a variety of devices. For example, gaming machines may have more stringent security requirements and fault tolerance requirements. Additionally, gaming machines generally operate in harsher environments as compared with PCs. For example, in a closed casino environment, the air may have a higher concentration of smoke and dust. Thus, adapting PC and other technologies to a gaming machine may be quite difficult.

Gaming machines may be very demanding with respect to amounts of electronic storage space, processing power, and display devices. Some components within gaming machines may generate significant heat, such as the central processing unit or master gaming controller (CPU), light sources, power supplies, transformers, displays, other electronic circuits, and so on. Accordingly, gaming machines often include a thermal management system to control the internal temperature of the game machine and dissipate heat. The thermal management system may generate an air flow through the gaming system and may include fans, baffles, temperature sensors, control signal alarms, and so on. The thermal management system is designed to channel the air flow through, on, or near heat generating components.

In some instances, thermal management systems may fail to adequately dissipate heat in gaming machines, causing reliability issues. Particulate buildup on the components being cooled may limit the effectiveness of the air flow generated by the thermal management system to cool such components. To reduce particulate buildup in gaming machine components, the air flow entering the gaming machines may be filtered before entering the gaming machine. However, these filters can become clogged, resulting in a diminished air flow and therefore reduced cooling. Maintenance may be performed to clean or replace the air filters to improve air flow. For example, maintenance is often performed on a scheduled basis by pulling the filter out and changing the filter or cleaning and replacing the cleaned filter if it is too dirty. However, in some instances, maintenance is not performed on the filters in accordance with the predetermined maintenance schedules. Further, even if maintenance is performed in accordance with the predetermined maintenance schedules, the predetermined maintenance schedules may not be correctly calibrated based on actual air quality conditions experienced by the gaming machine. For example, different areas of the casino may have different levels of airborne contaminants, and casino-wide maintenance schedules may not accurately reflect such variations. If the levels of airborne contaminants experienced by a particular gaming machine are lower than expected, then unnecessary service costs may be incurred when a service technician visually inspects a filter that is not yet in need of maintenance. Conversely, if the levels of airborne contaminants experienced by a particular gaming machine are higher than expected, then the filter may become clogged prior to its scheduled maintenance date. Fan failures due to air filter contamination may cause processors to overheat and shut down, which may cause down time of the gaming machine and also a shortening of the lifespan of the gaming machine.

Another cause of air flow reduction or loss may be an obstruction located near the air flow inlet of the gaming machine. The obstruction may be a clogged filter, an intentional blockage of the air inlet (such as someone trying to cheat the machine), or an unintentional blockage of the air inlet (such as a purse up against the machine). Again, this may cause the processors to overheat and shut down, which may cause down time of the gaming machine and also a shortening of the lifespan of the gaming machine.

### SUMMARY

According to various example embodiments, an air flow indicator is used to measure the speed of air flow through a gaming machine. The air flow cools components of the gaming machine and is filtered by a filter. The air flow indicator may be used to detect decreases in the speed of the air flow when the filter is in need of maintenance (e.g., clogged or dirty). The air flow indicator may also indicate other maintenance issues, such as a failed fan or an obstruction in the air flow path through the gaming machine.

According to one example embodiment, a method of cooling components of a gaming machine comprises generating an air flow through the gaming machine. The air flow cools the gaming machine components and is filtered by a filter. The method further comprises measuring a speed of the air flow through the gaming machine using an anemometer and generating a signal indicative of the speed of the air flow.

According to another example embodiment, a gaming machine comprises gaming machine components configured to cooperate in providing a gaming experience to a user, a main cabinet that houses the gaming components, and a thermal management system configured to cool the gaming components. The main cabinet has an air inlet and an air outlet formed therein. The thermal management system includes a fan, a filter, an anemometer, and an interface circuit. The fan is configured to drive an air flow from the air inlet to the air outlet to cool the gaming components. The filter is in fluid communication with the air inlet and the air outlet and filters particulates from the air flow. The anemometer is in fluid communication with the air inlet and the air outlet and is configured to measure a speed of the air flow through the filter. The interface circuit is coupled to the anemometer and is configured to generate a signal indicative of the speed of the air flow.

### BRIEF DESCRIPTION OF THE DRAWINGS

FIG. 1A is a perspective drawing of a gaming device in accordance with an embodiment of the present disclosure;

FIG. 1B is a block diagram of a gaming device in accordance with an example embodiment of the present disclosure;

FIG. 2 is a block diagram of a gaming system according to an example embodiment of the present disclosure;

FIG. 3 is a schematic diagram showing construction and operation of a thermal management system configured to cool components of the gaming machine according to an example embodiment;

FIG. 4 is a flow chart showing operation of a thermal management system according to an example embodiment;

FIG. 5 an example embodiment of an air flow indicator according to an example embodiment.

### DETAILED DESCRIPTION

Numerous specific details may be set forth below to provide a thorough understanding of concepts underlying the described embodiments. It may be apparent, however, to one skilled in the art that the described embodiments may be practiced without some or all of these specific details. In other instances, some process steps have not been described in detail in order to avoid unnecessarily obscuring the underlying concepts.

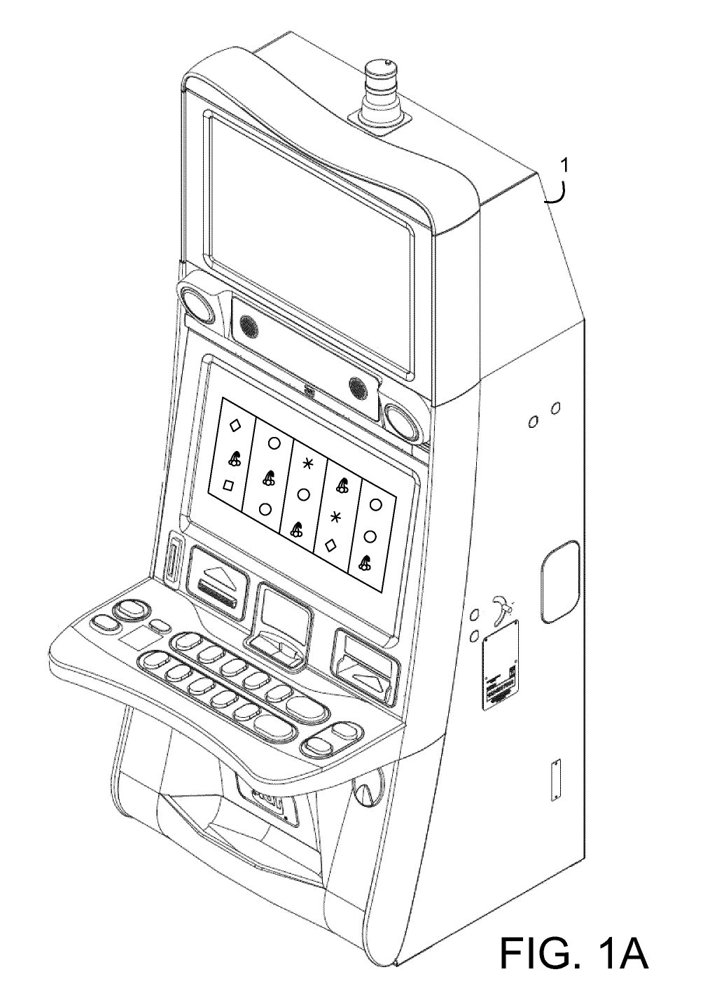

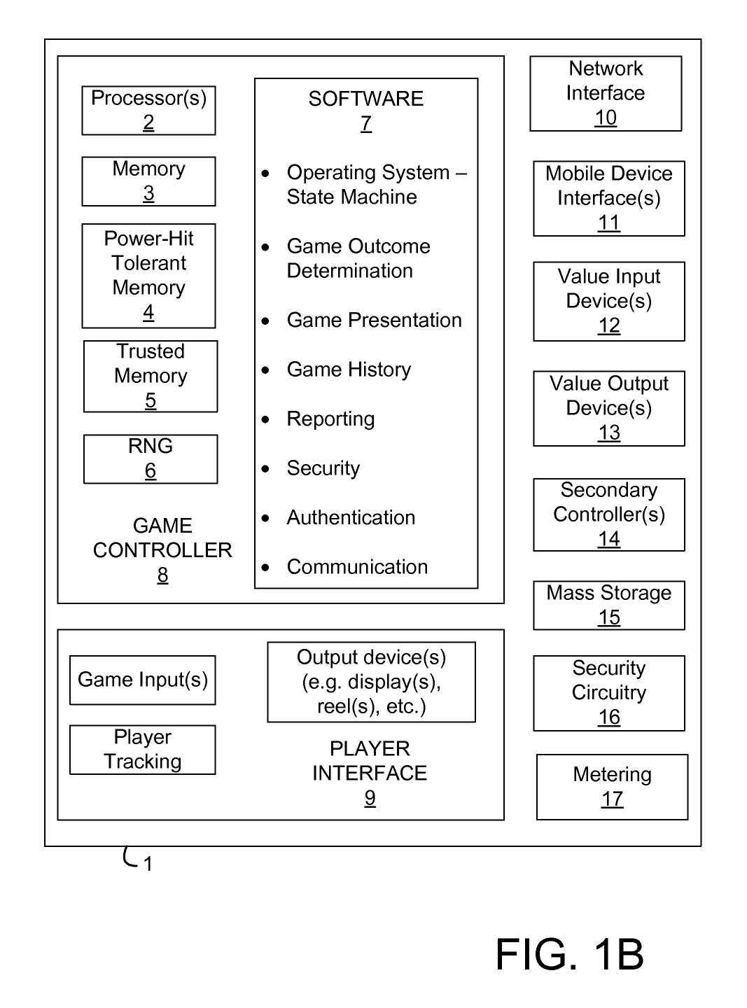

FIG. 1A shows a perspective drawing of a gaming device 1 in accordance with an embodiment. A gaming device 1 may be, but may not be limited to, a slot-type gaming device, electronic gaming device, table gaming device, or the like. The gaming device 1 may be capable of handling cash or gaming credits, or may allow player-users to play for free. The gaming device 1 may communicate with one or more servers or devices or may be standalone. Thus, features of gaming device 1 may be described for the purposes of illustration only and are not be meant to be limiting.

FIG. 1B is a block diagram of a gaming device 1 in accordance with an embodiment. A gaming device 1 may include a player interface 9, a game controller 8, a network interface 10, mobile device interface(s) 11, value input devices 12, value output devices 13, secondary controllers 14, mass storage 15, security circuitry 16, and metering 17.

In various embodiments, gaming device 1 may include a player interface 9 that may allow input from a player-user, such as a wager amount, associated with a wager-based game, to be made. The player interface 9 may facilitate communication of an outcome of a game or other information related to a game to a player-user. An outcome of a game may be displayed, shown, described, transmitted, or otherwise communicated to a player-user or another device through an output device 9.

The output device 9 may include, but may not be limited to, one or more electro-mechanical reels, video displays, any visible or audible devices that may disclose or describe an outcome of a game, network devices that may communicate an outcome of a game to another device, or the like.

In various embodiments, the gaming device 1 may include a game controller 8 that may control a wager-based game played on a gaming device 1. In some embodiments, a game controller 8 includes one or more processors 2, memory 3 for holding, among other things, software executed by one or more processors 2, power-hit tolerant memory 4, trusted memory 5, one or more random or pseudo-random number generator(s) (RNG) 6, and software application(s) 7. One or more of the components of a game controller 8 and/or one or more of the components of the player interface 9 may be coupled, directly or indirectly, by a system bus.

In various embodiments, the gaming device 1 utilizes a “state” machine architecture. In a state machine architecture, critical information in each state is identified and queued for storage to persistent memory. The architecture does not advance to the next state from a current state until all of the critical information that is queued for storage for the current state is stored to persistent memory. Thus, if an error condition occurs between two states, such as a power failure, the gaming device 1 implementing the state machine can likely be restored to its last state prior to the occurrence of the error condition using the critical information associated with its last state stored in persistent memory. This feature is often called a “roll back” of the gaming device. Examples of critical information can include, but are not limited to, an outcome determined for a game, a wager amount made on the wager-based game, an award amount associated with the outcome, credits available, and/or the amount of credits deposited to the gaming device 1.

The processing unit 2 may include one or more electronic processors (by hardware, software, or both) which may perform functions described herein. In various embodiments, a processing unit 2 (processor) may output information to an output device 9. Some embodiments may use just one processor 2 in a gaming device 1, while others may use multiple processors 2. In some embodiments involving multiple processors 2, processors 2 may be in the same gaming device 1, while in others, processors 2 may be distributed among a network of gaming device(s) 1, server(s), and/or other devices.

In various embodiments, memory 3 may be any non-transient data-storage device that can store data which may thereafter be read by a system that may execute software 7. Examples of memory 3 may include, but are not limited to, read-only memory (ROM), random-access memory (RAM), CD-ROMs, DVDs, electrically erasable programmable read-only memory (EEPROM), field programmable gate array (FPGA), flash memory, compact disk, magnetic tape, magnetic disk, and other magnetic storage devices, and optical data-storage devices, or the like. The memory 3 may be distributed over network-coupled systems so that software 7 may be stored and executed in a distributed fashion. A non-transient memory 3 may include volatile memory, non-volatile memory, and/or combinations of volatile and non-volatile memory.

According to various embodiments, power-hit tolerant memory 4 may be used as persistent memory for critical data, such as critical data associated with maintaining a state machine on a gaming device 1. One characteristic of a power-hit tolerant memory 4 may be a fast data transfer time. Thus, in the event of a power-failure, which might be indicated by a sudden power fluctuation, critical data may be quickly loaded from volatile memory, such as RAM associated with a processor 2, into a power-hit tolerant memory 4 and saved.

In some embodiments, a gaming device 1 may detect power fluctuations and in response, may trigger a transfer of critical data from RAM to a power-hit tolerant memory 4. One example of a power-hit tolerant memory 4 may be a battery-backed RAM. A battery supplies power to a normally volatile RAM so that, in the event of a power failure, data may not be lost. Thus, a battery-backed RAM may also be referred to as a nonvolatile RAM or NV-RAM. An advantage of a battery-backed RAM may be that fast data transfer times associated with a volatile RAM may be obtained.

In various embodiments, a trusted memory 5 may be ROM of some type that may be designed to be unalterable. An EPROM or EEPROM are two types of memory that may be used as a trusted memory 5, but it may not be limited to those types. Other types of memories, such as Flash memory, may be utilized as an unalterable memory. In various embodiments, a gaming device 1 may include one or more trusted memories.

Prior to installation, contents of a trusted memory 5 may be verified. For instance, a unique identifier, such as a hash value, may be generated on the contents of a memory and then may be compared to an accepted hash value for the contents of the memory. The memory may not be installed if generated and accepted hash values do not match. After installation, a gaming device 1 may check contents of a trusted memory 5. For instance, a unique identifier, such as a hash value, may be generated on contents of a trusted memory 5 and may be compared to an expected value for a unique identifier. If a generated value of a unique identifier and an expected value of a unique identifier do not match, then an error condition may be generated on a gaming device 1. In some embodiments, an error condition may result in a gaming device 1 which may enter a “tilt” state in which game play may be temporarily disabled on a gaming device 1.

Sometimes, verification of software executed on a gaming device 1 may be performed by a regulatory body, such as a government agency. Often software used by a game controller 8 may be highly regulated, where only software approved by a regulatory body may be allowed to be executed by a game controller 8. A trusted memory 5 may store authentication programs and/or authentication data for authenticating the contents of various memories on a gaming device 1. For instance, a trusted memory 5 may store an authentication program that may be used to verify contents of a mass storage device, which may include software which may be executed by a game controller 8.

According to various embodiments, RNG 6 may be used to generate random or pseudo-random numbers for use in determining outcomes for a game of chance played on a gaming device 1. In one exemplary embodiment of a mechanical or video slot reel type of game, an RNG 6, in conjunction with a paytable that may list possible outcomes for a game of chance and associated awards for each outcome, may be used to generate random or pseudo-random numbers for determining reel positions that may display randomly determined outcomes to a game. Typically, as described above, outcomes generated on a gaming device 1 may be considered critical data. Thus, generated outcomes may be stored to a power-hit tolerant memory 4.

Not all gaming devices 1 may be “thick” clients. They may not all generate their own game outcomes and thus may not use RNG 6 for this purpose. Game outcomes may be generated on a remote device, such as server, and then may be transmitted to a gaming device 1 where an outcome and an associated award may be displayed to a player via a player interface 9.

In other embodiments, a gaming device 1 may be used to play central-determination games. In a central-determination game, a pool of game outcomes may be generated and then particular game outcomes may be selected as needed (e.g., in response to a player requesting to play a central-determination game) from a pool of possibly previously-generated outcomes. A pool of game outcomes for a central-determination game may be generated and stored on a server. In response to a request to play a central-determination game on gaming device 1, one outcome from a pool may be downloaded to a gaming device 1. A game presentation that may include a downloaded outcome may be displayed on a gaming device 1.

A game controller 8 may utilize and execute many different types of software applications 7. Typically, software applications 7 utilized by a game controller 8 may be highly regulated and may undergo a lengthy approval process before a regulatory body allows software applications 7 to be utilized on a gaming device 1 that may be deployed in the field, such as in a casino. One type of software application 7 a game controller may utilize is an Operating System (OS). An OS may allow various programs to be loaded for execution by a processor 2, such as programs for implementing a state machine on a gaming device 1. Further, an OS may be used to monitor resource utilization on a gaming device 1. For instance, certain applications, such as applications associated with game outcome generation and game presentation that may be executed by the OS, may be given higher priority to resources, such as a processor 2 and memory 3, than other applications that may be executing simultaneously on a gaming device.

As previously described, a gaming device 1 may execute software 7 for determining an outcome of a game and generating a presentation of a determined game outcome that may include displaying an award for a game. As part of a game outcome presentation, one or more of 1) electro-mechanical devices, such as reels or wheels, may be actuated, 2) video content may be output to video displays, 3) sounds may be output to audio devices, 4) haptic responses may be actuated on haptic devices or 5) combinations thereof, may be generated under control of a game controller 8. Peripheral devices used to generate components of a game outcome presentation may be associated with a player interface 9 where types of devices that may be utilized for a player interface 9 may vary from device to device.

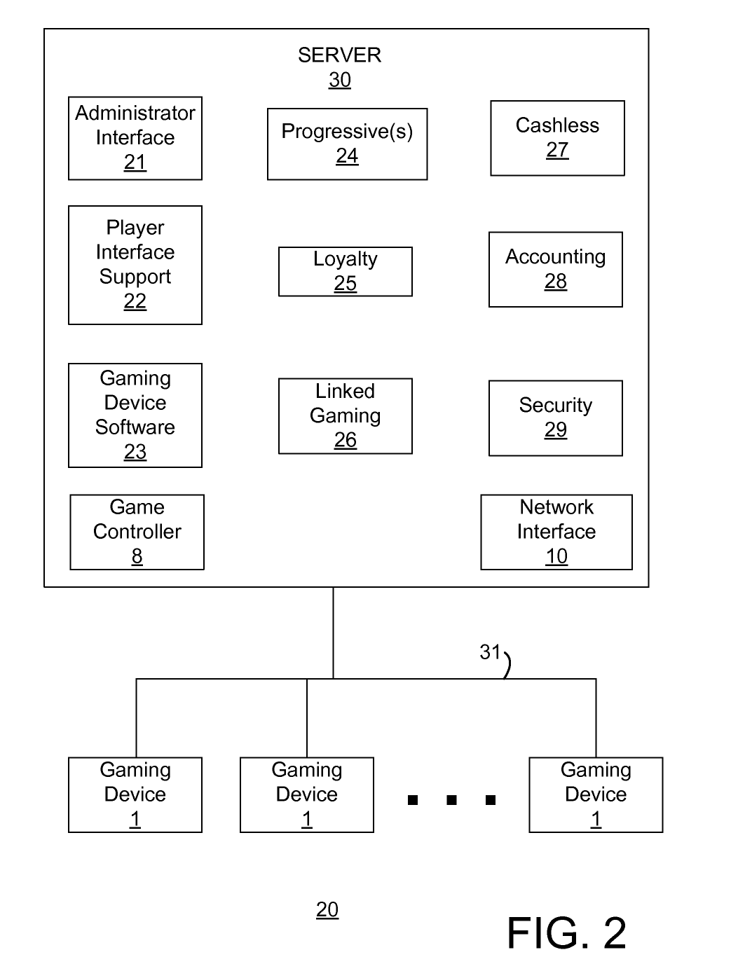

With reference to FIGS. 1B and 2, in various embodiments, a gaming device 1 may communicate with one or more remote devices via one or more network interfaces 10. Via network interfaces 10 and a network 31, a gaming device 1 may communicate with other gaming devices 1. Network interfaces 10 may provide wired or wireless communications pathways for a gaming device 1. Gaming devices 1 may not include a network interface 10 or may operate in a stand-alone mode where a network interface 10 may not be connected to a network 31.

In other embodiments, a mobile device interface or interfaces 11 may be provided for communicating with a mobile device, such as, but not limited to, a cell phone, smartphone, PDA, tablet computer, laptop, or the like, that may be carried by player-users or casino personnel at least temporarily in the vicinity of a gaming device 1. A wireless communication protocol, such as Bluetooth™, IrDA, ultrasonic multitone, FSK or PSK, a Wi-Fi compatible standard, or other protocol may be used for communicating with mobile devices via mobile device interface(s) 11. The mobile device interface(s) 11 may implement a short-range communication protocol, such as, but not limited to, a near-field communication (NFC) protocol used for mobile wallet applications. A wired communication interface, such as a docking station, may be integrated into a gaming device 1. A wired communication interface may provide communications between a gaming device 1 and a mobile device, and/or to provide power to a mobile device.

With reference to FIG. 1B, according to some embodiments, a gaming device 1 may include one or more value input devices 12 and/or one or more value output devices 13. Value input devices 12 may be used to deposit cash or indicia of credit onto a gaming device. Cash or indicia of credit may be used to make wagers on games played on a gaming device 12. Examples of value input devices 12 include, but are not limited to, a magnetic-striped card, smart card reader, USB memory device, bill and/or ticket acceptor, network interface for downloading credits from a remote source, wireless communication interface for reading credit data from nearby devices, and a coin or token acceptor.

Value output device(s) 13 may dispense cash, indicia of credit, or the like from a gaming device 1. Examples of value output devices 13 include, but are not limited to, a network interface for transferring credits into a remote account, wireless communication interface that may be used with a mobile device implementing mobile wallet application(s), coin hopper for dispensing coins or tokens, bill dispenser, smart card writer, magnetic-striped card writer, USB memory device, and printer for printing tickets or cards redeemable for cash or credits. Another type of value output device 13 may be a merchandise dispenser, which may dispense merchandise with a tangible value from a gaming device 1.

In some embodiments, a gaming device 1 may not include a value input device 12 or a value output device 13. Instead, a remote account may be used to maintain credits or amounts won or lost. An account may be accessed directly or indirectly by a gaming device 1 such that an account balance may be adjusted as a result of game play on a gaming device 1. In other embodiments, there may be no value input device 12 or a value output device 13 because a gaming device 1 may be meant for free play and not wagering.

According to some embodiments, a gaming device 1 may include one or more secondary controllers 14. Secondary controller(s) 14 may be associated with various peripheral devices coupled to a gaming device 1, such as value input device(s) 12 and value output device(s) 13. Secondary controller(s) 14 may be associated with peripheral devices associated with a player interface 9, such as, but not limited to, input devices, video displays, electro-mechanical displays and/or a player tracking unit. In some embodiments, a secondary controller(s) 14 may receive instructions and/or data from, and may provide responses to, a game controller 8. Secondary controller(s) 14 may interpret instructions and/or data from a game controller 8 and may control a particular device according to received instructions and/or data. For instance, a print controller may receive a print command with a number of parameters, such as a credit amount and, in response, print a ticket redeemable for a credit amount. In another example, a touch screen controller may detect touch inputs and send information to a game controller 8 that may characterize a touch input.

According to some embodiments, a secondary controller 14 may control a number of peripheral devices independently of a game controller 8. For instance, a player tracking unit may include one or more of a video display, a touch screen, card reader, network interface, or input buttons. A player tracking controller may control these devices to provide player tracking services and bonusing on a gaming device 1. In some alternate embodiments, a game controller 8 may control these devices to perform player tracking functions.

In various embodiments, functions of a gaming device 1 that may not be subject to as much regulatory scrutiny as game play functions may be decoupled from a game controller 8 and implemented on a secondary controller 14 instead. An advantage of this approach is that software approval process for software which may be executed by a secondary controller 14 may be less intensive than a process needed to get software approved for a game controller 8.

According to some embodiments, one or more mass storage unit(s) 15, such as, but not limited to, a device including a hard drive, optical disk drive, flash memory, or some other memory storage technology may be used to store applications and data used and/or generated by a gaming device 1. For instance, in some embodiments, a mass storage unit 15 may be used to store gaming applications that may be executed by a game controller 8 that may have been downloaded from remote device(s), such as a server 30. A game controller 8 may include its own dedicated mass storage unit 15. In other embodiments, critical data, such as game history data that may have been stored in a power-hit tolerant memory 4, may be moved from a power-hit tolerant memory 4 to a mass storage unit 15 at periodic intervals for archival purposes and/or to free up space in a power-hit tolerant memory 4.

In various embodiments, a gaming device 1 may include security circuitry 16, such as, but not limited to, security sensors and circuitry for monitoring sensors. Security circuitry 16 may operate while a gaming device 1 may be receiving direct power and may be operational to provide game play, as well as when a gaming device 1 may be uncoupled from direct power, such as during shipping or in an event of a power failure. A gaming device 1 may be equipped with one or more secure enclosures, which may or may not include locks for limiting access to enclosures. One or more sensors may be located within secure enclosures or coupled to locks. Sensors may generate signals that may be used to determine whether secure enclosures have been accessed, locks have been actuated or a gaming device 1 has been moved to an unauthorized area. Security monitoring circuitry may generate, store, and/or transmit error events when security events, such as, but not limited to, accessing an interior of a gaming device, have occurred. In some further embodiments, an error event may cause a game controller 8 to place itself in a “safe” mode such that no game play may be allowed until an error event may be cleared.

According to various embodiments, a gaming device 1 may include a metering function 17. Metering function 17 keeps track of information relating to operation of a gaming device 1. Information metered may include, but is not limited to, betting frequency, betting patterns, and/or betting amount(s) of a player-user or the player-users of a gaming device 1. Metering function 17 may increment a game play meter as each game is played. A recent play meter may be incremented for each recent game played. A recent play meter may reset for a new session, new time period, or the like. An accumulated wager meter may track an amount wagered during recent play.

FIG. 2 illustrates a block diagram of a gaming system 20 in accordance with an embodiment. In various embodiments, a gaming system 20 may include one or more servers 30 and one or more gaming devices 1. Gaming devices 1 may be located in publicly accessible areas, such as a casino floor, and a server(s) 30 may be located in publicly inaccessible areas, such as in a back-room of a casino or in a location separate from a casino.

Gaming device(s) 1 and server(s) 30 communicate with one another via a network 31, using network interfaces 10. A network 31 may include wired, wireless, or a combination of wired and wireless communication connections and associated communication routers. In some embodiments, method(s) and/or system(s) discussed throughout may be operated in a networked environment using logical connections to one or more remote devices or computers having processors. Logical connections may include a local area network (LAN) and a wide area network (WAN) that may be presented here by way of example and not limitation. Such networking environments may be commonplace in office-wide or enterprise-wide networks, intra nets, and the Internet. Those skilled in the art may appreciate that such network computing environments may typically encompass many types of computing configurations, including personal computers, hand-held devices, multi-processor systems, microprocessor-based or programmable consumer electronics, network PCs, minicomputers, mainframe computers, and the like.

In various embodiments, server 30 may provide one or more functions to gaming devices 1 or other server(s) 30 in a gaming system 20. Functions may be divided among multiple servers 30 with a result that each server 30 may communicate with a different combination of gaming device(s) 1. For instance, player interface support 22 and gaming device software 23 may be provided on a first server 30, progressives 24 may be provided on a second server 30, loyalty program functions 25 and accounting 28 may be provided on a third server 30, linked gaming 26 may be provided on a fourth server 30, cashless functions 27 may be provided on a fifth server 30, and security functions 29 may be provided on a sixth server 30. Each server 30 may communicate with a different combination of gaming devices 1 if each of the functions provided by a servers 30 may not be provided to every gaming device 1 in a gaming system 20.

In various embodiments, a server(s) 30 may include a game controller 8 with one or more components of a game controller 8 of a gaming device 1, such as, but not limited to, a processor(s) 2, memory 3, power-hit tolerant memory 4, trusted memory 5, RNG 6, and/or software 7.

According to various embodiments, server 30 may include an administrator interface 21 that allows functions associated with a server 30 to be initialized, adjusted, and/or maintained.

In some embodiments, a player interface support 22 may serve content to gaming devices 1. The content may include video and/or audio content to be output through a player interface(s) 9 of one or more gaming devices 1. Content may utilize unique features of a particular player interface 9, such as video displays, wheels or reels, if a particular player interface 9 is so equipped.

In some embodiments, via a player interface support 22, content may be output to all or a portion of a primary video display that may be used to output game outcomes on a player interface 9 that may be associated with a gaming device 1. For instance, a portion of a primary display may be allocated to provide a “service window” on a primary video display such that content in a service window may be provided from a server 30 remote to a gaming device 1. Content delivered from a server 30 to a gaming device 1 as part of a player interface support 22 may be affected by inputs made through a player interface 9 of a gaming device 1. For instance, a service window may be generated on a touch screen display where inputs may be received via a service window may be sent to server 30 through a network interface 10. In response to received inputs, a server 30 may adjust content that may be displayed on a gaming device 1.

According to various embodiments, if a player's identity is known, a player interface support 22 may be used to provide custom content to a gaming device 1. For instance, a player-user may provide identification information, such as information indicating membership in a loyalty program, during their utilization of a gaming device 1. Custom content may then be selected to meet an identified player-user's interests. A player-user's identity and interests may be managed via a loyalty program account associated with loyalty function 25. Custom content may include notifications, advertising, specific offers, or the like, that may be determined to be likely of interest to a player-user.

In various embodiments, a gaming device software function 23 may be used to provide downloads of software for a game controller 8 and/or second controllers 14 may be associated with peripheral devices on a gaming device 1. For instance, gaming device software 23 may allow an operator and/or a player-user to select a new game for play on a gaming device 1. In response to a game selection, gaming device software function 23 may cause game software to be downloaded that may allow a game controller 8 to generate a selected game. In response to determining that a new counterfeit bill has been submitted to bill acceptors 12 in a gaming system 20, a gaming device software function 23 may cause a new detection algorithm to be downloaded to a gaming device 1 that allows a counterfeit bill to be detected.

According to some embodiments, a progressive gaming function 24 may implement progressive game play on one or more gaming devices 1. A portion of wagers associated with play of a progressive game may be allocated to one or more progressive jackpot(s). A group of gaming devices 1 may support play of a progressive game and contribute to one or more progressive jackpot(s). Gaming devices 1 contributing to progressive jackpot(s) may be a group of gaming devices 1 located near one another, such as a bank of gaming machines on a casino floor, a group of gaming devices 1 distributed throughout a single casino, group of gaming devices 1 distributed throughout multiple casinos (e.g., a wide-area progressive), or a group of mobile devices connected via the Internet. A progressive gaming function 24 may keep track of jackpot contributions from each of the gaming devices 1 participating in a progressive game, determine current jackpot(s), and/or notify participating gaming devices 1 of current progressive jackpot amount(s), which may be displayed on participating gaming devices 1.

In some embodiments, a loyalty function 25 may implement a loyalty program, for example, within a context of a casino enterprise. A loyalty function 25 may receive information regarding activities such as gaming and non-gaming activities and may associate activities with particular player-users. player-users may be known, or they may be anonymous. A loyalty function 25 may store a record of activities associated with particular individuals and/or preferences of individuals. Based upon information stored with a loyalty function 25, “comps” (e.g., free or discounted services, such as a free game), promotions, and/or custom contents may be served to particular player-users.

According to some embodiments, a linked gaming function 26 may provide game play activities involving player-users participating as a group via multiple gaming devices. For example, a group of player-users may be competing against one another as part of a slot tournament. For another example, a group of player-users may be working together in attempt to win a bonus that may be shared among a group.

In some embodiments, a cashless function 27 may enable redemption and/or dispensation of cashless instruments on a gaming device 1. For instance, via cashless function 27, printed tickets may be used to transfer credits from one gaming device 1 to another gaming device 1. A cashless function 27 may generate identifying information that may be stored to a cashless instrument, that may allow an instrument to later be authenticated. After authentication, a cashless instrument may be used for additional game play, redeemed for cash or other credits at another gaming machine 1, or the like.

According to some embodiments, an accounting function 28 may receive transactional information from various gaming devices 1 within a gaming system 20. Transactional information may relate to value deposited on each gaming device, value dispensed from each gaming device, or the like. Transactional information, which may be received in real-time, may be used to assess performance of each gaming device 1, to assess an overall performance of a gaming system 20, and/or for tax and auditing purposes.

In some embodiments, a security function 29 may combat fraud and crime. Security function 29 may receive notification(s) of a security event that may have occurred on a gaming device 1, such as an attempt at illegal access. Security function 29 may receive transactional data that may be used to identify if gaming devices 1 may be being utilized in a fraudulent or unauthorized manner. Security function 29 may receive, store and analyze data from multiple sources, including, but not limited to, detection device located on a gaming device 1 and/or detection device, such as cameras, distributed separately from gaming device(s) 1. In response to detecting a security event, security function 29 may notify security personnel of an event.

It may be understood that many makes, models, types and varieties of gaming machines exist, that not every such gaming machine may include all or any of the foregoing items, and that many gaming machines may include other items not described above.

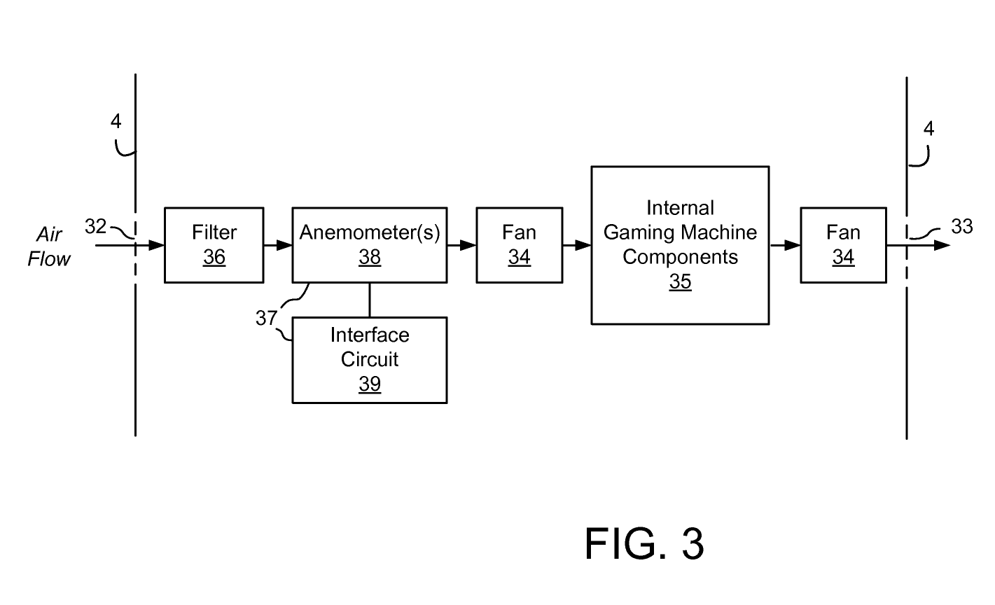

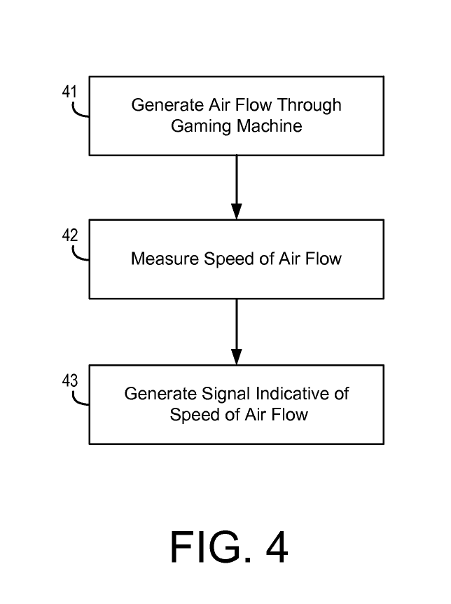

Referring now to FIGS. 3-4, FIG. 3 is a schematic diagram showing construction and operation of a thermal management system configured to cool components of the gaming machine 1. FIG. 4 is a flow chart showing operation of the thermal management system. With reference first to FIG. 3, the main cabinet 4 of the gaming machine 1 has an air inlet 32 and an air outlet 33 formed therein. The thermal management system may include one or more fans 34 that are configured to drive an air flow from the air inlet 32 to the air outlet 33 to cool internal gaming components 35 of the gaming machine 1 (FIG. 4, step 41). The internal gaming components 35 may include the components and portions thereof shown in FIGS. 1A-1B that are located internally to the main cabinet 4 of the gaming machine 1. For example, the air flow may be channeled through, on, or near heat generating components. As will be appreciated, although the air flow in FIG. 3 is shown to be in a single direction, in practice, the air flow may take a circuitous three-dimensional route through the gaming machine 1.

The thermal management system may further include a filter 36 that is in fluid communication with the air inlet 32 and the air outlet 33 and that filters the air flow through the gaming machine 1. Specifically, the filter 36 may be used to filter particulates from the air flow to reduce particulate build-up within the gaming machine 1.

The thermal management system may further include an air flow indicator 37 which in turn includes one or more anemometer(s) 38 and an interface circuit 39. The anemometer(s) 38 are in fluid communication with the air inlet 32 and the air outlet 33. While the filter 36 and the anemometer(s) 38 are shown as being in a particular order in the air flow relative to each other and relative to the fan(s) 34 and the internal gaming machine components 35, as will be appreciated, this ordering is merely by way of example and alternative orderings of the components 34-38 within the air flow through the gaming machine 1 may also be used.

The anemometer(s) 38 are configured to measure a speed of the air flow through the filter 36 (FIG. 4, step 42). Specifically, in an example embodiment, the interface circuit 39 may be configured to heat the anemometer(s) 38 and then detect the rate of cooling of the anemometer(s) 38 after such heating. For example, the anemometer(s) 38 may be an electrical element (e.g., a hot wire resistor, a solid state semiconductor, etc.) that heats up when an electrical power (e.g., a current) is applied. Further, the anemometer(s) 38 may have electrical properties that vary in a known way as a function of temperature. For example, conductivity of the electrical element may vary as a function of temperature. Thus, for a known current, different voltage drops may be exhibited across terminals of the electrical element depending on the temperature of the electrical element. By applying a current to the electrical element to heat the electrical element above ambient temperature, then removing the current, and then measuring the rate of decay of the voltage across the terminals of the electrical element over time, a direct measurement of the speed of the air flow adjacent the electrical element may be obtained. That is, if the air flow is relatively stagnant (lower air speed), the anemometer(s) 38 will take longer to cool after such heating. Conversely, if the air flow is not stagnant (higher air speed), the anemometer(s) 38 will require less time to cool after such heating. As another example, rather than removing power entirely, the electrical element may be driven with a PWM signal with varying duty cycles depending on whether the electrical element is in heating or cooling mode.

The interface circuit 39 may be configured to generate a signal indicative of the speed of the air flow (FIG. 4, step 43). The signal generated by the interface circuit 39 may then be communicated to other circuitry to request servicing of the gaming machine 1. For example, the signal may drive LEDs or alarms, trigger the game controller 8, trigger a message to be displayed in a service window of a touch screen display of the gaming machine 1, generate a signal to be transmitted to server 30 via network interface 10, flash the candle on the top of the gaming machine 1, and so on. For example, trip points may be created to turn on indicators (such as LEDs) reflecting the speed of air flow through the filter 36. For example, trip points may be created to delineate speeds corresponding to a clean air filter, a filter that will soon be in need of replacing, and a filter that is currently in need of replacing. Thus, diminishing air flow through the filter 36 from the initial setting of a clean filter may be made apparent to a service technician. A warning indicator may show that there is an airflow issue which may potentially cause overheating of the internal components 35.

The air flow indicator 37 may thus alert a service technician that the filter 36 needs to be replaced or that the air flow is otherwise obstructed. This eliminates the need for a service technician to pull out the air filter 36 to determine if the air filter 36 has excessive dirt, replace the filter 36 according to a predetermined maintenance schedule, or replace the filter 36 before the scheduled maintenance date due to unexpected dirt buildup. Instead, the filter 36 may be replaced or cleaned precisely when such action is needed as indicated by the air flow indicator 37, i.e., based on the actual condition of the filter as opposed to based on a predetermined generic maintenance schedule. For example, if the gaming machine 1 is operating in an environment with a lesser amount of particulates in the air, then the filter 36 may not need to be cleaned or replaced as often as might be suggested by a predetermined generic maintenance cycle. Hence, the maintenance cycles may be lengthened, maintenance costs may be reduced, and down time of the gaming machine may be minimized. Conversely, if the gaming machine 1 is operating in an environment with a greater amount of particulates in the air, then the filter 36 may be replaced before overheating of components of the gaming machine 1 occurs. Hence, in this scenario, reliability of the gaming machine 1 may be enhanced.

Additionally, the air flow indicator 37 may also provide warnings regarding other air flow issues. For example, if the fan 34 fails, such failure may result in a reduced air flow that may be detected by the air flow indicator 37. Likewise, if there is an obstruction located in the path of the air flow through the gaming machine 1, the obstruction may result in a reduced air flow that may be detected by the air flow indicator 37.

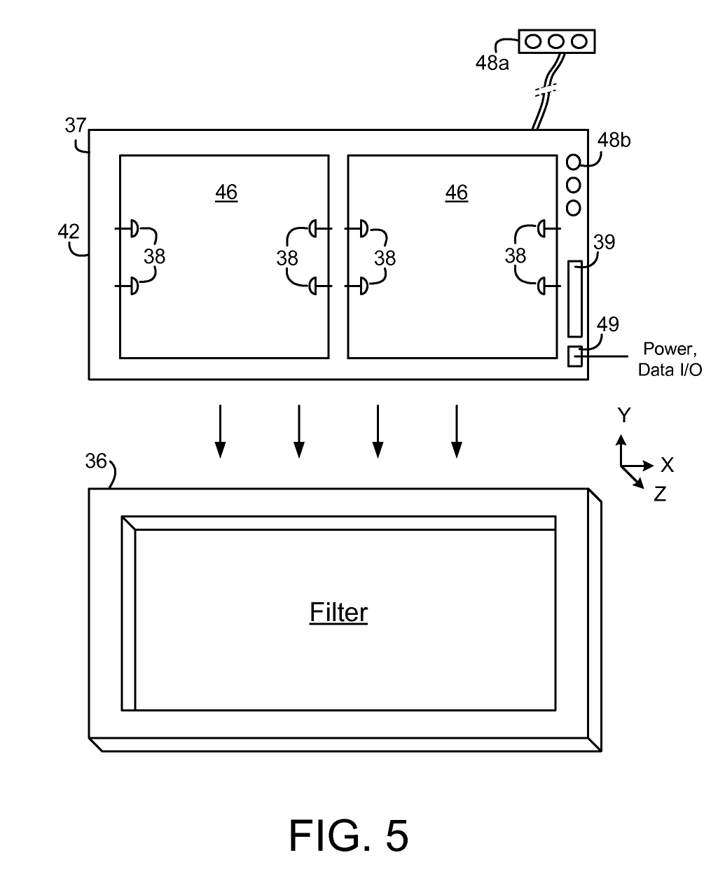

Referring now to FIG. 5, an example embodiment of the air flow indicator 37 is shown. As previously indicated, the air flow indicator 37 may comprise anemometers 38 and an interface circuit 39. As shown in FIG. 5, in an example embodiment, the anemometers 38 are mounted on a circuit board 45 having a shape that matches the shape of the filter 36. Specifically, if (as shown in FIG. 5) air flows in direction Z through the filter, and X and Y are orthogonal to Z, then the shape of the circuit board 45 in the X and Y dimensions may match the shape of the filter 36 in the X and Y dimensions.

As shown in FIG. 5, the circuit board 45 may have open interior portions 46 formed therein to permit air flow through the circuit board 45. Air flowing past the anemometers 38 has a cooling effect on the anemometers 38, as described above. In the arrangement of FIG. 5, the anemometers 38 are thru-hole mounted on the circuit board 45 (e.g., as opposed to employing newer surface-mount technology) so as to extend further out into the air flow.

In an example embodiment, the anemometers 38 are transistors (e.g., SCRs). In another example embodiment, the anemometers 38 are hot wire anemometers constructed of a very fine wire (e.g., on the order of several micrometers). As previously described, in operation, the anemometers 38 may be electrically heated up to a temperature above ambient temperature. Air flowing past the anemometers 38 has a cooling effect on the anemometers 38, and the speed of the air flow can be measured based on the rate of cooling.

In addition to the circuit board 45, the air flow indicator 37 may also comprise one or more LED indicators 48a, 48b and a power and I/O port 49. The indicators 48a and 48b may be configured to provide a visual indication to a service technician regarding the speed of the air flow inside the gaming machine 1. For example, a “red-yellow-green” scheme may be used to signal varying levels of urgency in connection with cleaning/replacement of the filter 36. Other arrangements may also be used. If the circuit board 45 is viewable from outside the gaming machine 1 (e.g., through a vent hole in the gaming machine 1), then an indicator 48a that is mounted on the circuit board may be employed. If the circuit board 45 is not viewable from outside the gaming machine 1, then an indicator 48b that is mounted on the outside of the gaming machine 1 and connected by wires to the circuit board 45 may be employed. As another example, as previously indicated, the signal generated by the interface circuit 39 may be provided to other circuitry. For example, the signal may be used to trigger alarms, trigger the game controller 8, trigger a message to be displayed in a service window of a touch screen display of the gaming machine 1, generate a signal to be transmitted to server 30, flash the candle on the top of the gaming machine 1, and so on. Such information may be communicated via I/O port 49. For example, the signal transmitted through port 49 may be a one bit signal (e.g., indicating air flow problem/no air flow problem), a multi-bit signal (e.g., indicating the measured speed of the air flow in the gaming machine 1), or another signal format.

In another example embodiment, in addition to measuring the speed of the air flow, the air flow indicator 37 may also be used to measure the direction of air flow. For example, the air flow indicator 37 may include baffles mounted adjacent one or more of the anemometers 38. Such baffles may permit air flow past the anemometers 38 but deflect such air flow to the extent that it is in a direction other than that sought to be measured. Further, by using orthogonally mounted baffles, a complete vector characterization of the air flow (magnitude in three orthogonal directions) at a particular location within the gaming machine may be obtained.

The various aspects, embodiments, implementations or features of the described embodiments can be used separately or in any combination. Various aspects of the described embodiments can be implemented by software, hardware, or a combination of hardware and software.

The foregoing description, for purposes of explanation, used specific nomenclature to provide a thorough understanding of the disclosure. However, it will be apparent to one skilled in the art that the specific details are not required in order to practice the disclosure. Thus, the foregoing descriptions of specific embodiments of the present disclosure are presented for purposes of illustration and description. They are not intended to be exhaustive or to limit the disclosure to the precise forms disclosed. It will be apparent to one of ordinary skill in the art that many modifications and variations are possible in view of the above teachings.

The embodiments were chosen and described in order to best explain the principles of the disclosure and its practical applications, to thereby enable others skilled in the art to best utilize the disclosure and various embodiments with various modifications as are suited to the particular use contemplated. It is intended that the scope of the disclosure be defined by the following claims and their equivalents.

While the embodiments have been described in terms of several particular embodiments, there are alterations, permutations, and equivalents, which fall within the scope of these general concepts. It should also be noted that there are many alternative ways of implementing the methods and devices of the present embodiments. It is therefore intended that the following appended claims be interpreted as including all such alterations, permutations, and equivalents as fall within the true spirit and scope of the described embodiments.

What is claimed is:

1. A method of cooling components of a gaming machine, comprising:
generating an air flow through the gaming machine, the air flow cooling the gaming machine components, and the air flow being filtered by a filter;
measuring a speed of the air flow through the gaming machine using an anemometer; and
generating a signal indicative of the speed of the air flow.

2. A method as defined in claim 1, wherein measuring the speed of the air flow further comprises:
applying electrical power to an electrical element of the anemometer thereby causing heating of the electrical element to a temperature that is above ambient temperature;
removing the electrical power from the electrical element; and
measuring a rate of cooling of the electrical element.

3. A method as defined in claim 2, wherein measuring the rate of cooling comprises monitoring changes in conductivity of the electrical element as the electrical element cools towards ambient temperature.

4. A method as defined in claim 1, further comprising using the signal to control a visual indicator, wherein the visual indicator indicates to a service technician that the gaming machine is in need of maintenance.

5. A method as defined in claim 1, further comprising transmitting the signal to a remote server to provide an indication that the gaming machine is in need of maintenance.

6. A gaming machine comprising:
gaming machine components configured to cooperate in providing a gaming experience to a user;
a main cabinet that houses the gaming components, the main cabinet having an air inlet and an air outlet formed therein;
a thermal management system configured to cool the gaming components, the thermal management system including
a fan configured to drive an air flow from the air inlet to the air outlet to cool the gaming components,
a filter in fluid communication with the air inlet and the air outlet to filter particulates from the air flow,
an anemometer in fluid communication with the air inlet and the air outlet and configured to measure a speed of the air flow through the filter, and
an interface circuit coupled to the anemometer and configured to generate a signal indicative of the speed of the air flow.

7. A gaming machine as defined in claim 6, wherein the interface circuit is further configured to
apply electrical power to an electrical element of the anemometer thereby causing heating of the electrical element to a temperature that is above ambient temperature;
remove the electrical power from the electrical element; and
measure a rate of cooling of the electrical element.

8. A gaming machine as defined in claim 7 wherein, to measure the rate of cooling, the interface circuit is configured to monitor changes in conductivity of the electrical element as the electrical element cools towards ambient temperature.

9. A gaming machine as defined in claim 6, wherein the thermal management system further comprises a circuit board, and wherein the anemometer is mounted on the circuit board.

10. A gaming machine as defined in claim 9, wherein the circuit board has a shape which matches in first and second dimensions a shape of the filter.

11. A gaming machine as defined in claim 10, wherein the circuit board has apertures formed therein to permit air flow through the circuit board.

12. A gaming machine as defined in claim 9, wherein the thermal management system comprises a plurality of anemometers, wherein the anemometer is one of the plurality of anemometers, and wherein the plurality of anemometers are mounted on the circuit board.

13. A gaming machine as defined in claim 9, wherein the anemometer is thru-hole mounted on the circuit board.

14. A gaming machine as defined in claim 6, wherein the thermal management system further comprises a visual indicator coupled to the interface circuit, wherein the visual indicator indicates to a service technician that the gaming machine is in need of maintenance.

15. A gaming machine as defined in claim 6, wherein the interface circuit is configured to transmit the signal to a remote server to provide an indication that the gaming machine is in need of maintenance.

16. An air flow indicator for a gaming machine comprising:
an anemometer configured to measure a speed of air flow through a filter in the gaming machine, and
an interface circuit coupled to the anemometer, the interface circuit being configured to measure a speed of the air flow through the gaming machine using the anemometer and generate a signal indicative of the speed of the air flow.

17. An air flow indicator as defined in claim 16, wherein the interface circuit is further configured to
apply electrical power to an electrical element of the anemometer thereby causing heating of the electrical element to a temperature that is above ambient temperature;
remove the electrical power from the electrical element; and
measure a rate of cooling of the electrical element.

18. An air flow indicator as defined in claim 17 wherein, to measure the rate of cooling, the interface circuit is configured to monitor changes in conductivity of the electrical element as the electrical element cools towards ambient temperature.

19. An air flow indicator as defined in claim 16, further comprising a circuit board, and wherein the anemometer is mounted on the circuit board.

20. An air flow indicator as defined in claim 19, wherein the circuit board has a shape which matches in first and second dimensions a shape of the filter.

21. An air flow indicator as defined in claim 20, wherein the circuit board has apertures formed therein to permit air flow through the circuit board.

22. An air flow indicator as defined in claim 19, wherein the anemometer is one of a plurality of anemometers that are mounted on the circuit board.

23. An air flow indicator as defined in claim 19, wherein the anemometer is thru-hole mounted on the circuit board.

24. An air flow indicator as defined in claim 16, further comprising a visual indicator coupled to the interface circuit, wherein the visual indicator indicates to a service technician that the gaming machine is in need of maintenance.

25. An air flow indicator as defined in claim 16, wherein the interface circuit is configured to transmit the signal to a remote server to provide an indication that the gaming machine is in need of maintenance.

26. A method of requesting servicing for a thermal management system of a gaming machine, comprising:
measuring a speed of air flow through a filter of the gaming machine; and
transmitting a request for servicing based on the speed of the air flow through the filter; and
wherein the request for servicing is transmitted based on actual condition of the thermal management system as indicated by the measured speed of the air flow and not based on a predetermined maintenance schedule.

27. A method as defined in claim 26, wherein measuring the speed of the air flow further comprises:
applying electrical power to an electrical element of the anemometer thereby causing heating of the electrical element to a temperature that is above ambient temperature;
removing the electrical power from the electrical element; and
measuring a rate of cooling of the electrical element.

28. A method as defined in claim 27, wherein measuring the rate of cooling comprises monitoring changes in conductivity of the electrical element as the electrical element cools towards ambient temperature.

29. A gaming machine comprising:
gaming machine components configured to cooperate in providing a gaming experience to a user;
a main cabinet that houses the gaming components, the main cabinet having an air inlet and an air outlet formed therein;
a thermal management system configured to cool the gaming components, the thermal management system including
a fan configured to drive an air flow from the air inlet to the air outlet to cool the gaming components,
a filter in fluid communication with the air inlet and the air outlet to filter particulates from the air flow,
an anemometer in fluid communication with the air inlet and the air outlet and configured to measure a speed of the air flow through the filter, and
an interface circuit coupled to the anemometer and configured to
apply electrical power to an electrical element of the anemometer thereby causing heating of the electrical element to a temperature that is above ambient temperature,
remove the electrical power from the electrical element,
measure a rate of cooling of the electrical element, and
generate, based on the rate of cooling, a signal indicative of the speed of the air flow.

30. A gaming machine as defined in claim 29 wherein, to measure the rate of cooling, the interface circuit is configured to monitor changes in conductivity of the electrical element as the electrical element cools towards ambient temperature.

31. A gaming machine as defined in claim 29, wherein the thermal management system further comprises a circuit board, wherein the thermal management system comprises a plurality of anemometers, wherein the anemometer is one of the plurality of anemometers, and wherein the plurality of anemometers are mounted on the circuit board, wherein the circuit board has apertures formed therein to permit air flow through the circuit board, and wherein the circuit board has a shape which matches in first and second dimensions a shape of the filter.

32. A gaming machine as defined in claim 31, wherein the anemometers are thru-hole mounted on the circuit board.

33. A gaming machine as defined in claim 29, wherein the thermal management system further comprises a visual indicator coupled to the interface circuit, wherein the visual indicator indicates to a service technician that the gaming machine is in need of maintenance.

34. A gaming machine as defined in claim 29, wherein the interface circuit is configured to transmit the signal to a remote server to provide an indication that the gaming machine is in need of maintenance.
